(19) United States
(12) Patent Application Publication
(10) Pub. No.: US 2021/0309001 A1
(43) Pub. Date: Oct. 7, 2021

(54) CORE AND METHOD FOR AUTOMATED HOLLOW DOOR AND PANEL ASSEMBLY

(71) Applicants: James Warren GERE, Pietermaritzburg (ZA); Michelle Joy SMITH, Pietermaritzburg (ZA)

(72) Inventors: James Warren GERE, Pietermaritzburg (ZA); Michelle Joy SMITH, Pietermaritzburg (ZA)

(21) Appl. No.: 17/262,810

(22) PCT Filed: Jul. 31, 2019
(86) PCT No.: PCT/ZA2019/050041

§ 371 Date: Jan. 25, 2021

(30) Foreign Application Priority Data
Jul. 25, 2018 (ZA) PCT/ZA2018/004990

(51) Int. Cl. B32B 29/08; E06B 3/70; B32B 7/14; B32B 3/28; B32B 29/00; B32B 37/12

(52) U.S. Cl. CPC B32B 29/08; E06B 3/7015; B32B 7/14; B32B 2419/00; B32B 29/005; B32B 37/1292; E06B 2003/7019; B32B 3/28

(57) ABSTRACT

This invention relates to a core for hollow door manufacture comprising a method whereby the mechanical arrangement of the core glue applicators produces multi sized closed cell filler material once severed and expanded wherein a combination of both contracting and expanding cells presents as a centrally aligned column of contracting cells while other cells expand utilizing adhesively affixed non rigid flexible single face corrugated material.

### FIELD OF THE INVENTION

This invention relates to a “stack and sever” method and an adhesion arrangement and method to assemble stable, adhesively affixed flexible single face core material once severed and expanded comprising centrally aligned column of cells that contract and narrow on said expansion while at the same time provide expanding cells of two other dimensions to fill the void area wherein this invention ideally seventy four closed cells of three distinct sizes and shapes (some seventy two percent more closed cells) when compared to similar known art eighteen ply corrugated rigid board core that typically presents forty three large same sized cells within similarly compared adhesively affixed core components.

This invention further provides core material comprising adhesion process and assembly method herein to produce the said core to accommodate molded portions of doorskins when the core is expanded while at the same time concentrating support with smaller cells on the vertical centrally aligned axis of the door void.

### BACKGROUND OF INVENTION

The use of individually laid up blocks and fillers between the molded spaces of panel doors is a time consuming and expensive production process where as the laying up of one piece rigid filler material in thinner doorskin applications is a challenge due to its rigidity and inclination to telescope a honeycomb imprint on the outer skin. Also, one piece known art door core material by its nature presents evenly intersected adhesion points that always expands to wide, evenly spaced open cells with a relatively large expanse between cell walls providing little support of the skin in the most vulnerable central axis of the door.

An additional challenge is the narrowing or misalignment of standard honeycomb leaving costly gaps within the inner door.

Multiple piece rigid material fillers are time consuming and labor intensive and rely on manual and accurate assembly within time pressured door construction lines.

The objective solution this invention provides to the industry is a reliable one piece horizontally stable low cost core material, its method to continuously assemble sheet material comprising a specific adhesive arrangement to assemble, providing sufficient crush without collapse in the raised and or indented molding while at the same time providing a centrally aligned series of vertically aligned elongated column of support cells along the spine of the door where essential support is needed to avoid delamination, dipping and swelling due to poor support and dubious adhesion between possibly undercut overcut door frame material and molded skin.

Another significant challenge of the industry is the hour glassing or narrowing of known art core when expanded in the centre of the door when traditional corrugated or rigid board filler is used. The placement of lock blocks onto stiles between rigid corrugated board core material is also a challenge in high speed automation plants. The objective solution of this invention provides method and adhesive arrangement of material to produce adhesively affixed core sheet material that eliminates narrowing or hour glassing of the filler and remains horizontally stable when expanded within the width of the door void to be filled. At the same utilizing pliable single face corrugated core material to accommodate the placement of lock blocks within the door frame.

The use of known art fillers between flat skin or veneer hollow core doors relies on the strength of the expanded filler to withstand pressing within fastest lay-up times while at the same produce a reliably pressed door.

However, rigid standard cardboard filler when expanded by its nature provides wide spaced cells and is inclined to narrow and curve to one side and the rigidity often results in an outline honeycomb imprint appearing on the surface of the skin particularly when lower grade or thinner flat skin materials are used, is a continuous challenge to the industry.

Another object of this invention provides method to produce a horizontally stable core material comprising lower cost flexible single face corrugated material which provides displacement of the material, without collapsing the wall of the filler material, along the inner surface of molded doorskins resulting in more stable pre-press stacking of multiple doors in cold press production resulting in larger pre-press stacks to improve press cycle times with larger volumes and lower reject rates of expensive doorskin and material caused by under or over cut frame material.

The object of this single face corrugated core invention providing centrally aligned narrow oblong support cells is a cost effective and practical solution for an industry who are challenged by hit and miss too rigid one piece cores where consistently large cells throughout the rigid material filler result in unstable filler and manufacturing inconsistencies and reworks or time consuming individually hand laid fillers.

A further object of this invention and its method is to enable the automated insertion of adhesively stable core material between rails or stiles essential for high volume door construction.

A further object of this invention is to provide the industry with accurately severed core material that doesn't necessitate sanding of core adhesion surface to achieve specification.

The additional option of providing more rigid surface laminated single face double material or corrugated or rigid board on each end of the filler material assists in automated production.

A further objective of this invention is essentially lowering moisture levels within the pressed door resulting from the single face corrugated material herein, wherein the single faced nature of this material allows for quicker release of moisture.

Moisture can be trapped between the liners and paper corrugations of standard corrugated board cores resulting in longer and costly curing times for the industry.

Likewise the density of rigid paper board core is inclined to typically retain moisture longer than single faced fluted corrugated core resulting in longer curing times.

In a further embodiment severing unexpanded core prior to door construction to accommodate lay up of individual pieces in a variety of molded panels is optional where the filler lies flush to the door frame to avoid tipping of multiple stacks of pre-press door components.

A most notable advantage of this invention in producing core filler materials is in the stack and sever method of materials herein whereby the necessity to sand the surface to customer specification is unnecessary. The known art “cut and stack” method of producing honeycomb demands that the skin to core surface of the filler is sanded to remove cut variances which often crush the fluting and can result in doorskin adhesion failure.

Weight for weight ratio of known art door eighteen ply core at ‘285 g’ (10.06 oz) per core compared to this typically twenty two ply invention at ‘295 g’ (10.4 oz) utilizing single face corrugated material available at a 34%-48% cost savings.

It is generally accepted in the door and panel making industry that smaller cells in core filler material will result in an improved pressing outcome.

This invention provides horizontally stable core that does not hourglass nor narrow and is sufficiently flexible to accommodate hinges and lock blocks in automated hollow door construction. Said core when expanded, centrally aligned cells contract and narrow to display a column of longitudinally aligned elongated cells on the vertical axis of the core thus improving hollow door support while at the same time providing significantly lower cost core material to the industry.

Current hollow door core materials are adhesively produced using essentially rigid cardboard where cells are evenly adhesively spaced to expand to consistently sized large open cells providing comparatively less support on the vulnerable vertical axis of the door. The rigid nature of the cardboard also tends to curve to one side with the added challenge in automated lines where the rigid nature of the core materials interfere with lock and hinge blocks. Other core materials comprise strips of slotted rigid cardboard wherein different size strips are assembled without adhesive. Also individually laid up pieces of core are time consuming.

Both U.S. Pat. No. 2,827,670 to Schwindt and U.S. Pat. No. 4,583,338 to Sewell, et al respectively using rigid paperboard strips have a tendency to curve to one side during door assembly and the rigid nature of the material interferes with lock and hinge blocks. Neither aforementioned patents therefore provide for horizontal stability on expansion of the core nor do either patents claim both contraction and expansion of cells on expansion of adhesively assembled core material.

U.S. Pat. No. 10,202,799 to Masonite Corporation provides a “cut and assemble” series of varied size interconnected rigid cardboard or corrugated cardboard core material strips where essentially to enable slit strips assembly of the core the heavy paper board material is rigid in nature and relatively more expensive to produce and assemble rigid strips. This patent also does not provide for contraction of cells as a single piece continuously adhesively affixed core as it is assembled in separate sections by cutting and slitting varied size strips of rigid material and conjoining sections.

Clearly there is a need to provide automated door assembly lines challenged by-

a. rigid materials that don't compensate for undercut or overcut frame materials

b. telescoping of rigid materials on thinner door skins

c. moisture retention within the walls of rigid and corrugated board materials

d. large open cells on the vulnerable vertical axis of the door

e. horizontally unstable core that interferes with lock and hinge blocks

f. the known “cut and stack” core assembly process that has to be sanded to achieve finished spec accuracy

and last but not least

e. cost of core materials.

The industry savings on material filler cost within this invention is conservatively estimated at 34% to 48% compared to known art rigid material core costs while additional savings resulting from-

a. sufficiently deformable core surface that withstands pressing while the flexible nature of the single face corrugated material compensates for under or overcut frame materials lowering rework and or reject rates of expensive materials

b. a deformable core surface that splays on the door skins rather than a single rigid “line” of traditional rigid cores that often telescopes on the door skin revealing an outline on the exterior of the doorskin

c. lower moisture retention in the core material resulting in quicker curing rates

d. smaller and narrower support cells on the vertical axis of the door

e. horizontally stable core that compensates for lock and hinge blocks.

Improved production line unit outputs

could be realized as herein by improving the assembly of door components in automated production lines.

### SUMMARY OF THE INVENTION

This invention relates to high volume assembly of door components whereby reliably stable adhesively affixed core is essentially formed from low cost flexible or non rigid single face corrugated sheet material and its specific adhesive method and arrangement to assemble and stacking method to produce single piece core providing horizontally stable core, whereby on longitudinal expansion of the core uniquely results in the contraction of centrally aligned smaller cells strategically adhesively vertically configured to provide narrow elongated support cells as well as horizontally expanding stable filler material within the door void.

The use of flexible single face corrugated paper material in this core results in high volume door production with significant material cost reduction while at the same time providing centrally aligned narrow cell walls when optimally expanded resulting in improved door skin support on the central vertical axis.

### Technical Problem

Traditionally rigid material core strips are machined by “cut and stack” (the invention herein is a stack method and sever) whereby traditionally core requires sanding to achieve accurate specifications. Overcut and undercut strips of rigid core material within known art outside of tolerance results in expensive failure and delamination of door materials.

### Solution to Problem

The use herein of flexible single face corrugated paper core assembled in stacks and accurately severed to exact customer specifications consistently results in a more accurate specification resulting in fewer delaminations and considerably lower door reject rates.

Traditionally door components are adhesively fixed where the quantity and cost of adhesive used is constantly monitored and particularly the glue adhesion between doorskins and the core.

As a cost saving measure the industry is inclined to apply adhesive to the core component rather than the doorskins. The cut surface area of the core therefore is vital.

### Further Solution to Problem

Historically the unexpanded or expanded adhesive application surface area of typically rigid strip assembled core, typically 18 ply standard corrugated or board core which by necessity has to be sanded is 50 mm/1.9″ inches, which is similar to the invention herein of twenty two ply single face corrugated core where the surface area is 46 mm/1.8″ inches but without having to sand the surface and considerable cost of core material savings to the industry.

### Advantageous Effects of Invention

The stacking and method of assembling core material of centrally aligned elongated narrow cells herein result in the elimination of misalignment or narrowing, hour glassing or telescoping of core material across the door width and provides additional support by stabilizing the expandable width of the core between door stiles and avoids misalignment, narrowing or telescoping as in standard prior art rigid and corrugated board honeycomb like core applications.

This surface area is significant when it is considered that 90% of the cohesion of door components relies on this surface area of the core component.

Other objects of the invention will become apparent upon consideration of the detailed description of the preferred embodiment of this invention taken with the accompanying drawings.

### BRIEF DESCRIPTION OF THE DRAWINGS

It is understood that the embodiments shown in the drawings are for the purpose of illustrating the preferred present embodiments and not limited to the precise arrangements shown in the drawings.

FIG. 1 is an internal perspective view of an example of a hollow core panel door “A” using this invention and with a portion of the molded panel skin removed for illustration of core 7.

FIG. 2 is an internal perspective view of a hollow core exterior flat skin door “B” using this invention and with a portion of the doorskin removed for illustration of core 7.

FIG. 3 is an end view of the adhesively assembled stack 23 from which core 7 in its unexpanded form illustrating the use of non rigid single face corrugated material comprising the body of the filler material.

FIG. 4 is an expanded view of the adhesively assembled core 7 constructed in flexible single face corrugated material of ideally twenty two sheets comprising ideally ten vertically arranged narrow cells 15 where the open cells on either end 19 of each last narrow oblong is attached to the rails 24 thereby facilitating on expansion the vertical arrangement of ten elongated narrow centrally aligned cells 14.

FIG. 5 is a view of core 7 material formed by surface adhesion of the single face corrugated material A, B and C and a plurality of specifically arranged adhesive lines 20 and 21 on each B and C surface within this invention laminated material C to seal the stack.

### DETAILED DESCRIPTION OF THE PREFERRED EMBODIMENT

Herein the preferred embodiment described is not intended to be exhaustive or to limit the application to the precise form disclosed herein. It is chosen to graphically demonstrate the method and material assembly principles of this invention and its application and practical use to illustrate the exemplary embodiments of the invention.

### EXAMPLES

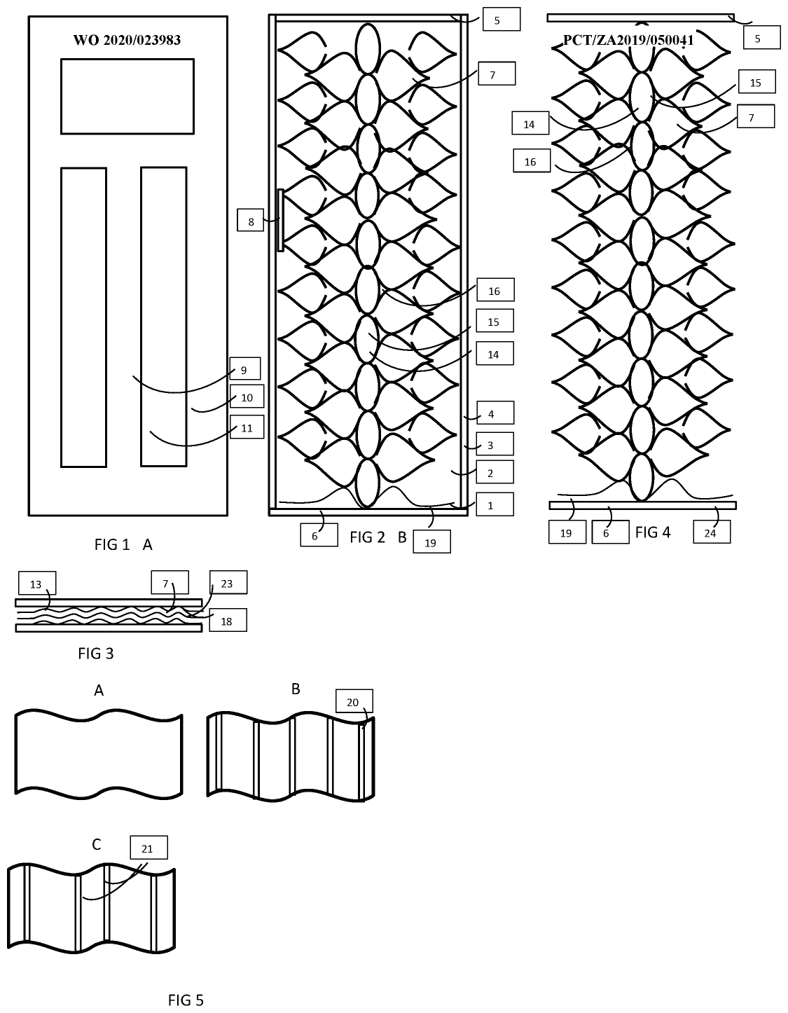

Hollow core door panel door “A” and flat skin door “B” is illustrated in FIG. 1-2 respectively includes an inner doorskin 1 and outer doorskin 2 joined by a peripheral frame 3 having two spaced parallel side stiles 4, upper rail 5 and a lower rail 6. Core 7 is placed in Door B and core 7 is placed respectively between the doorskins 1 and 2 within the peripheral door frame 3. Door “A” and “B” also includes a lock block 8 placed adjacent to the frame vertical side stiles 4 and into which the lock set is fitted.

FIG. 1 panel door “A” illustrates formed into each doorskin 1 and 2 is a series of molded raised or indented panels 9 each outlined by a raised or indented molding 10 formed in the surface of the doorskin. Door A is shown with a series of panels 11.

FIG. 1 Core 7 is vertically expanded and either loose laid or affixed to rails 5 and 6 as shown FIG. 4 as with respect to the Door “A” and overlies panels 11 and raised or indented moldings 9 of inner door skin 1.

Filler 7 is vertically expanded with respect to door “A” and overlies flush with frames in relation to panels 9 and moldings 10 of inner door skin 1. Core 7 at optimum expansion forms a vertically and centrally arranged series of ideally ten elongated narrow centrally aligned cells 15 but not limited to that number of narrow oblong shapes 15 located overlying middle length of the doorskin 1.

FIG. 2 illustrates flat skin door construction Door “B” where core 7 is vertically expanded and affixed 19 to rails 5 and 6 as shown in FIG. 4 with respect to door size B and overlies flat doorskin of inner door skin 1.

FIGS. 1 and 2 in Both Door A and B:

Filler 7 is of elongated narrow centrally aligned cell 14 showing oblong 15 and triangle 16 within central elongated narrow centrally aligned cell 14 and comprising adhesive arrangement 20 and 21 on material B and C as illustrated in FIG. 5 in application Doors “A” and “B” and FIG. 3-4 in its unexpanded form and expanded form respectively.

It is the use of a number of ideally twenty two ply of flexible void material but not limited to that number of single face corrugated material 18 in Stack FIG. 3 and ideally ten but not limited to that number central elongated narrow centrally aligned cell 14 cell size 15 and 16 of core 7 formed by the relationship between the positioning of the seven glue points 20 and four glue points 21 illustrated in FIG. 5 that permits the positioning of the elongated narrow more compact cells as illustrated 14 as a narrow oblong 15 and as a triangular shape 16 on either side of 15 to be placed along the vertical length of the inner doorskin 1 and sandwiched between doorskin 2 to cause a substantially improved support portion of the central axis of the Door “A” and “B” to be supported.

Filler 7 is made of ideally twenty two flexible single faced corrugated paper sheets 18 FIG. 3 showing stacked and adhesively affixed sheets 20 and 21 in the specific format illustrated in FIG. 5 where the centre clusters of open end cells present when expanded elongate as distinct narrow oblong 15 with triangle shape 16 on each side of the oblong 15 along the central length of the filler material. This method and schematic layout of laminating and stacking of material results in the expanded core in FIG. 4.

FIG. 5. Filler 7 is laminated FIG. 5 in a method and sequence of unlaminated sheet A stacked corrugated face up followed by Sheet B laminated as shown 20 and stacked face down followed by multiple stacking of preferably single face corrugated sheets 20 and 21 and stack closed by one corrugated face down laminated sheet 20 to seal the stack. The stack FIG. 3 is pressed, cured and cut cross section to form individual ready to use strips 13 from the stack. (One shown)

Filler 7 laid up in door “A” and “B” pressed and trimmed within known art.

FIG. 3 illustrates unexpanded view of individual strip 13 the method assembly of the stack 23 from which strip 13 is transversely severed whereby Materials B and C are presented for adhesion 20 and 21 on each alternate surface stacked adhesively FIG. 5 in a continuous cycle to required size. (0047) FIG. 5 where sheets Material B is presented for adhesion 20 stacked corrugated face down and Material C presented for adhesion 21 corrugated face up are laid down adhesively stacked in a continuous cycle of Materials B and C until the required customer specification is met, ideally but not limited to twenty two ply.

Stack is sealed with Material B presented for surface adhesion 20 corrugated face down to seal the said stack, pressed and from which strip 13 is severed and presented expanded as a void filler.

Core 7 method herein presented when expanded FIG. 4 whereby ideally ten but not limited to elongated narrow centrally aligned cells 14 consist of narrow oblongs 15 and triangle 16 shapes on either side of oblong 15 are presented.

FIG. 4 is an expanded view of core 7 showing method of fixing 19 to upper and lower rails 5 and 6 of the ideally assembled but not limited to core constructed in flexible material ideally but not limited to 1160 mm wide twenty two ply material with ten vertically arranged narrow cells 15 where the open cells on either end of each last narrow oblong is attached to the rails as shown 19 thereby displaying the vertical arrangement of ideally but not limited to ten elongated narrow centrally aligned cells longitudinally positioned along the length of the core illustrating the contraction of the centrally aligned elongated narrow cells 14 to narrow oblong shapes 15 with a triangle shape 16 on either side within the column when expanded.

Illustrating assembly method of stack FIG. 3 adhesive fixing process and method in FIG. 5 and assembly FIG. 3.

FIG. 5 illustrates Material A stacked adhesive free corrugated face up and thereafter Material B surface laminated 20 and stacked corrugated face down thereafter Material C stacked adhesive 21 stacked corrugated face up and the positioning of the adhesive layout 20 and 21 on alternate surfaces of Materials B and C stacked continuously as Material B illustrate positioning of seven glue 20 adhesion points and on Material C illustrate positioning of four glue 21 adhesion points.

The stacking thereafter of materials B and C in sequence FIG. 3 results in the unique formation when filler 7 expanded as shown in FIG. 4 of ideally ten elongated narrow 14 centrally aligned cells arranged on the vertical axis void material with the method of completing the stack with surface laminated Material B adhesion layout 20 to seal the stack 23.

### INDUSTRIAL APPLICABILITY

It is intended that this invention covers all modifications and variations as may be applicable to the embodiment principles set out above provided any variation comes within the scope of the claims to follow and their equivalents.

It is understood that the invention is not to be limited to the precise form disclosed in the preferred embodiment but may be modified without departing from the scope of the invention as defined in the claims to follow herein.

### REFERENCES CITED PATENTS

2,073,896 A 3/1937 Loctscher

2,173,808 A 9/1939 Kellogg

2,272,227 A 2/1942 Thomas

2,511,620 A 6/1950 MacMillan

2,660,766 A 12/1953 Petterson

2,695,430 A 11/1954 Wakefield

2,824,630 A 2/1958 Tolman

2,827,670 A 3/1958 Schwindt

2,849,758 A 9/1958 Plumley

2,893,076 A 7/1959 Herts

3,385,002 A 5/1968 Quinif

3,404,502 A 10/1968 Miller

4,294,055 A 10/1981 Andersen

4,550,540 A 11/1985 Thorn

4,583,338 A *4/1986 Sewell. E06B 3/&017 428/116

4,922,674 A 5/1990 Thorn

5,052,164 A 10/1991 Sandow

5,157,892 A 10/1992 Ryther

5,167,105 A 12/1992 lsban et al

5,417,788 A 5/1995 Holt

5,644,870 A 7/1997 Chen

5,875,608 A 3/1999 Quinif

5,992,127 A 11/1999 Quinif

6,132,836 A 10/2000 Quinif

6,892,993 A 5/2005 Palmer

9,085,933 A 7/2015 Crittenden

2003/0033786 2/2003 Yulkowski

2006/0037281 2/2006 Yong et al

2006/0269720 11/2006 Guanci

2009/0183455 07/2009 Polk et al

2012/0048487 03/2012 Brewster et al

1. A method for making a core component for a door or panel comprising the steps of adhesively affixing non rigid flexible single face corrugated sheets into stacks wherein the adhesive layout on a said sheet is dimensionally unevenly intersected by its a corresponding sheet thus forming, on severing a strip off stack and expansion of said strip, a central column of horizontally contracting narrow oblong cells while at the same time presenting other horizontally and vertically expanding cells whereby disposing an expanded core within a known art door frame and components having stile and rail members and adhesively secure a first and second door skin of flat or molded panels to opposite sides of the frame and thereby enclosing the core.

2. The method of claim 1 wherein the disposing step comprises adhesively affixing sheets with unevenly intersected adhesion points by stacking a plurality of flexible single face sheets to form the said stack, severing a strip or core wherein the arrangement of two specific adhesion points typically 230 mm apart but not limited to that distance on a sheet is unevenly intersected by two non corresponding adhesion points of typically 250 mm but not limited to that size on the following sheet, method and alternate stacking multiples of said sheets ideally but not limited to twenty two flexible single face corrugated sheets.

3. The method of claim 2 wherein the said first sheet material is also unevenly intersected by a third size of 280 mm spaced glue application on second sheet as shown.

4. A core made by a method comprising the steps of adhesively affixing non rigid flexible single face corrugated sheets into stacks wherein the adhesive layout on a said sheet is dimensionally unevenly intersected by its a corresponding sheet thus forming, on severing a strip off stack and expansion of said strip, a central column of horizontally contracting narrow oblong cells while at the same time presenting other horizontally and vertically expanding cells whereby disposing an expanded core within a known art door frame and components having stile and rail members and adhesively secure a first and second door skin of flat or molded panels to opposite sides of the frame and thereby enclosing the core. wherein the disposing step comprises adhesively affixing sheets with unevenly intersected adhesion points by stacking a plurality of flexible single face sheets to form the said stack, severing a strip or core wherein the arrangement of two specific adhesion points typically 230 mm apart but not limited to that distance on a sheet is unevenly intersected by two non corresponding adhesion points of typically 250 mm but not limited to that size on the following sheet, method and alternate stacking multiples of said sheets ideally but not limited to twenty two flexible single face corrugated sheets,
wherein the said first sheet material is also unevenly intersected by a third size of 280 mm spaced glue application on second sheet as shown,
the core comprised of adhesively stacked non rigid flexible single face corrugated sheet material wherein the disposing step comprises the spatial arrangement of two sets of adhesive points as shown.

5. The method of claim 1 comprising the step of adhesively securing said expanded core to door rail members and coating edge of said core to bond to said door skins.

6. The core made by the method of claim 1 wherein the said central column of longitudinal cells are oblong in shape contract on expansion of said core into said door frame as a direct result of the said non rigid flexible single face corrugated sheet material and method in claim 2.

7. The core made by the method of claim 1, wherein the cells on expansion of the said core present open cells of multiple shapes both contracting and expanding on expansion of the core disposed of by the nature of the said flexible material introduced to the spatial layout of two sets of glue adhesion point applicators in claim 2 as shown.

8. A core made by a method comprising the steps of adhesively affixing non rigid flexible single face corrugated sheets into stacks wherein the adhesive layout on a said sheet is dimensionally unevenly intersected by its a corresponding sheet thus forming, on severing a strip off stack and expansion of said strip, a central column of horizontally contracting narrow oblong cells while at the same time presenting other horizontally and vertically expanding cells whereby disposing and exanded core within a known art door frame and components having stile and rail members and adhesively secure a first and second door skin of flat or molded panels to opposite sides of the frame and thereby enclosing the core,
wherein the method of stacking multiple sets of said sheet material B and C as shown whereby said base sheet A as shown is laid down adhesive free corrugated face up and thereafter sets of sheets B and C alternately stacked adhesively affixed Sheet B as corrugated face down followed by said sheet C adhesively fixed stacked corrugated face down as shown herein thereby sealing the stack with adhesively affixed said sheet B.

9. A core made by a method comprising the steps of adhesively affixing non rigid flexible single face corrugated sheets into stacks wherein the adhesive layout on a said sheet is dimensionally unevenly intersected by its a corresponding sheet thus forming, on severing a strip off stack and expansion of said strip a central column of horizontally contracting narrow oblong cells while at the same time presenting other horizontally and vertically expanding cells whereby disposing an expanded core within a known art door frame and components having stile and rail members adhesively secure a first and second door skin of flat or molded panels to opposite sides of the frame and thereby enclosing the core,
wherein the method of stacking multiple sets of said sheet material B and C as shown whereby material B adhesion and corrugation face up as shown is laid down followed by material C adhesion face up corrugation face down as shown whereafter said base sheet A as shown is laid down adhesive free corrugated face down thereby sealing the stack.

10. A door comprising inner and outer skin said skins having panels formed wherein each outlined by raised moldings on the interior surface of the skin, a peripheral frame and lock block secured said skins and a core component made by a method comprising the steps of adhesively affixing non rigid flexible single face corrugated sheets into stacks wherein the adhesive layout on a said sheet is dimensionally unevely intersected by its a corresponding sheet thus forming, on severing a strip off stack and expansion of said strip, a central column of horizontally contracting narrow oblong cells while at the same time presenting other horizontally and vertically expanding cells whereby disposing an expanded core within a known art door frame and components having stile and rail members and adhesively secure a first and second door skin of flat or molded panels to opposite sides of the frame and thereby enclosing the core,
and method as shown to separate the said door skins in a spatial arrangement.

11. A door comprising inner and outer skins said skins having flat interior surfaces, a peripheral frame and lock block secured said skins and a core component made a method comprising the steps of adhesively affixing non rigid flexible single face corrugated sheets into stacks wherein the adhesive layout on a said sheet is dimensionally unevenly intersected by its a corresponding sheet thus forming, on severing a strip off stack and expansion of said strip, a central column of horizontally contracting narrow oblong cells while at the same time presenting other horizontally and vertically expanding cells whereby disposing an expanded core within a known art door frame and components having stile and rail members and adhesively secure a first and second door skin of flat or molded panels to opposite sides of the frame and thereby enclosing the core,
and method as shown to separate the said door skins in a spatial arrangement.

12. A core made by a method comprising the steps of adhesively affixing non rigid flexible single face corrugated sheets into stacks wherein the adhesive layout on a said sheet is dimensionally unevenly intersected by its a corresponding sheet thus forming, on severing a strip off stack and expansion of said strip, a central column of horizontally contracting narrow oblong cells while at the same time presenting other horizontally and vertically expanding cells whereby disposing an expanded core within a known art door frame and components having stile and rail members and adhesively secure a first and second door skin of flat or molded panels to opposite sides of the frame and thereby enclosing the core,
the core once severed from stack as herein once expanded is ready to use as a filler material whereby no further tolerance sanding of the severed surface is required.
